(19) United States
(12) Patent Application Publication
(10) Pub. No.: US 2014/0153375 A1
(43) Pub. Date: Jun. 5, 2014

(54) OPTICAL INFORMATION RECORDING MEDIUM, METHOD FOR MANUFACTURING SAME AND RECORDING METHOD FOR OPTICAL INFORMATION RECORDING MEDIUM

(71) Applicant: FUJIFILM Corporation, Tokyo (JP)

(72) Inventors: Akiko HENMI, Odawara-shi (JP); Tatsuo MIKAMI, Odawara-shi (JP); Hidehiro MOCHIZUKI, Odawara-shi (JP); Toshio SASAKI, Odawara-shi (JP)

(73) Assignee: FUJIFILM Corporation, Tokyo (JP)

(21) Appl. No.: 14/175,267

(22) Filed: Feb. 7, 2014

Related U.S. Application Data
(63) Continuation of application No. PCT/JP2012/066147, filed on Jun. 25, 2012.

(30) Foreign Application Priority Data
Sep. 12, 2011 (JP) 2011-198297
Nov. 21, 2011 (JP) 2011-253759

(51) Int. Cl. G11B 7/24027; G11B 7/24024

(52) U.S. Cl. CPC G11B 7/24027; G11B 7/24024
USPC 369/100; 428/523; 428/215; 428/212; 156/182

(57) ABSTRACT

An optical information recording medium comprises recording layers which include a polymer binder and a dye dispersed in the polymer binder or include a polymer to which a dye is bonded, and each recording layer has a refractive index unchangeable under irradiation with a recording beam, with first and second interfaces being defined between the recording layer and two intermediate layers adjacent thereto. Irradiation of a region of the recording layer adjacent to the first interface or a region of the recording layer adjacent to the second interface with the recording beam causes the dye to absorb the recording beam and generate heat which in turn deforms the polymer in the recording layer, forming a protrusive shape protruding into an intermediate layer at the first or second interface whereby information is recordable in separate information layers at both of the first and the second interfaces.

### CROSS-REFERENCE TO RELATED APPLICATION(S)

This application is a continuation of International Application No. PCT/JP2012/066147 filed on Jun. 25, 2012, which claims priority from Japanese Patent Application Nos. 2011-198297 and 2011-253759 filed on Sep. 12, 2011 and Nov. 21, 2011, respectively, in the Japan Patent Office, the disclosures of which are herein incorporated by reference in their entirety.

### BACKGROUND

1. Field

The present invention relates to an optical information recording medium, a method for manufacturing the same and a recording method for an optical information recording medium.

2. Description of Related Art

In recent years, among techniques for increasing the capacity of an optical information recording medium, a three-dimensional recording technique of recording information in multiple layers formed in a one-sheet recording medium has been a focus of study. In the optical information recording medium for three-dimensional recording, typically, intermediate layers each having an appropriate thickness are provided between a plurality of recording layers in order to prevent crosstalk between the recording layers.

An optical information recording medium disclosed in Patent literature 1 is configured, for the purpose of simplifying fabrication process for multiple recording layers, such that information is recorded near upper and lower interfaces of a single recording layer so as to provide two separately formed information layers therein. To be more specific, a multiphoton absorption compound is used for the recording layers, and a first information layer is formed in a recording layer by changing a refractive index of a portion defined strictly near an upper interface of the recording layer, and a second information layer is formed in the recording layer by changing a refractive index of a potion defined strictly near a lower interface of the recording layer. With these process steps, two information layers can be formed in a single recording layer, and thus, the number of recording layers can be reduced on conditions that the same number of information layers are to be formed, so that the manufacturing process for the medium can be simplified.

### CITATION LIST

### Patent Literature(s)

Patent Literature 1: JP 2009-277271 A

However, in the optical information recording medium disclosed in Patent literature 1, recording spots (pits) are formed by changing the refractive indices of regions adjacent to the upper and lower interfaces of the recording layer; therefore, during the reading process, an interference would occur between light reflected off the interface and light reflected off a border between a non-recorded portion of the recording layer and the recording spot (such an interference will be referred to as “interference occurring intrinsically in the recording spot” for convenience's sake). In other words, when spots for recording in a recording layer are irradiated with light, the upper interface of one recording spot formed thereby (e.g., interface between an intermediate layer and the recording layer) reflects light, which would interfere with light reflected off the lower interface of the same one recording spot (e.g., interface between a portion of which a refractive index has not changed and a portion of which a refractive index has changed), and such interference would possibly prevent information from being retrieved stably.

It would thus be desired to provide an optical information recording medium in which a new recording method is used and information can thereby be retrieved stably, a method for manufacturing the same, and a recording method for an optical information recording medium.

### SUMMARY

In one aspect of the present invention, an optical information recording medium is provided which comprises a plurality of recording layers, and intermediate layers provided between the plurality of recording layers, which intermediate layers are made of adhesive layers. Each recording layer includes a polymer binder and a dye dispersed in the polymer binder, or includes a polymer to which a dye is bonded, the recording layer having a refractive index unchangeable under irradiation with a recording beam, with first and second interfaces being defined between the recording layer and two intermediate layers adjacent thereto; the optical information recording medium is configured such that irradiation of a region of the recording layer adjacent to the first interface or a region of the recording layer adjacent to the second interface with the recording beam causes the dye to absorb the recording beam and generate heat which in turn deforms the polymer in the recording layer, forming a protrusive shape protruding into the intermediate layer at the first or second interface whereby information is recordable in separate information layers at both of the first and the second interfaces.

With this optical information recording medium, information is recordable in separate information layers at two interfaces (first interface and second interface) of the recording layer, and thus the number of recording layers can be reduced on conditions that the same number of information layers are to be formed, so that the manufacturing process for the optical information recording medium can be simplified. Furthermore, in this optical information recording medium, information (recording spots) is formed by utilizing deformation of the first interface and the second interface while refractive indices of regions of the recording layer near the first and second interfaces do not change when information is recorded; therefore, there is no potential for interference to occur intrinsically in the recording spot during the reading process. Accordingly, information can be read stably.

In the optical information recording medium described above, the recording layer may preferably have a thickness not less than 2 micrometers.

Provision of the recording layer with a thickness not less than 2 micrometers as such can serve to suppress influence (cross talk), on one of two recording spots formed at one of the first and second interfaces in one recording layer, of noises from the other of the recording spots formed at the other of the first and second interfaces in the same recording layer, when information is to be read from the one of the recording spots.

In the optical information recording medium described above, the first and second interfaces may be configured to have the same reflectivity. In other words, the reflectivity of each layer may be adjusted to the same reflectivity

With this configuration, each interface (information layer) at which recording is to be effected has the same reflectivity, which makes a detection system for the reading operation easily configurable.

To realize the same reflectivity of the first and second interfaces, the recording layer may be configured to include a polymer to which a dye is bonded. This is because when a polymer to which a dye is bonded is applied, even if a relatively thick film is formed, variations in refractive index distribution along, its thickness will not occur.

In the optical information recording medium describe above, the first and second interfaces may be configured to have different reflectivities.

With this configuration, the position of a specific information layer can be determined with ease increased by using the reflectivity of each interface.

To realize such different reflectivities of the first and second interfaces, the recording layer may be configured to include a polymer binder and a dye dispersed in the polymer binder.

When a dye dispersed in a polymer binder is used to form a recording layer having a reasonable thickness by application thereof, variations in concentration of the dye will occur in the thickness direction of the layer; therefore, a difference can be made between the reflectivity of the first interface and the reflectivity of the second interface.

In the optical information recording medium described above, it is preferable that the dye includes a multiphoton absorption compound. If a multiphoton absorption compound is used as a dye for recording, change can be effected in, a limited range in the thickness direction; this is advantageous to increase in the number of the information layers.

A method for manufacturing an optical information recording medium according to each aspect described above may be configured to comprise the steps of: forming unit structure sheets in which a recording layer, and an adhesive layer are laminated between two release sheets; and removing one of the release sheets from one unit structure sheet and laminating the same on another unit structure sheet from which the other of the release sheets are removed.

Since the optical information recording medium is made by using an adhesive layer as an intermediate layer, a method of lamination of unit structure sheets, as described above, which is suitable to mass production can be utilized.

A recording method for an optical information recording medium according to another aspect of the present invention comprises the steps of: providing an optical information recording medium including a plurality of recording layers and intermediate layers, wherein each recording layer includes a polymer binder and a dye dispersed in the polymer binder or includes a polymer to which a dye is bonded, the recording layer having a refractive index unchangeable under irradiation with a recording beam, and the intermediate layers are made of adhesive layers and provided between the plurality of recording layers; irradiating a condensed recording beam in a region of the recording layer adjacent to one of interfaces between the recording layer and the intermediate layers, the one of the interfaces being located on one side in a thickness direction of the recording layer, thereby deforming the one of the interfaces into a protrusive shape protruding into the corresponding intermediate layer, to record information; and irradiating a condensed recording beam in a region of the recording layer adjacent to the other of the interfaces between the recording layer and the intermediate layers, the other of the interfaces being located on the other side in the thickness direction of the recording layer, thereby deforming the other of the interfaces into a protrusive shape protruding into the corresponding intermediate layer, to record information.

With this recording method, a large number of information layers can be formed by a small number of recording layers; further, information can be read out stably as the change in reflectivity of the recording layers is not utilized therefor.

The above aspects and advantages, and other advantages and further features of the present invention will become more apparent by a detailed description of illustrative, non-limiting embodiments of the present invention which will be given below with reference to the accompanying drawings.

### BRIEF DESCRIPTION OF THE DRAWINGS

FIG. 1 is, a sectional view of an optical information recording medium.

FIG. 2 is a diagram showing a recording spot formed at the time of recording information.

FIG. 3 is a diagram for explaining the state at the time of reading information.

FIG. 4 is a diagram for explaining the process of forming a recessed shape in an optical information recording medium.

FIG. 5 is a diagram for explaining a manufacturing process for an optical information recording medium.

FIG. 6 is a diagram for explaining a layer structure of a sample according, to an Example.

FIG. 7 represents the result of imaging of the intensity of reflection on a substrate-side interface after recording is effected thereon, which imaging is performed by a reading apparatus.

FIG. 8 represents the result of imaging of the intensity of reflection on a plane taken along a position that is 5 micrometers inside a recording layer from the substrate-side interface after recording is effected on the substrate-side interface, which imaging is performed by, the reading apparatus.

FIG. 9 represents the result of imaging of the intensity of reflection on a cover-side interface before recording is effected thereon after recording is effected on the substrate-side interface, which imaging is performed by the reading apparatus.

FIG. 10 represents the result of imaging of the intensity of reflection on a cover-side interface after recording is effected thereon after recording is effected on the substrate-side interface, which imaging is performed by the reading apparatus.

FIG. 11 is an image of the recording spots observed by an atomic force microscope.

FIG. 12 (a) represents the measurements of reflectivity vs. positions along the thickness direction in the optical information recording medium according to Example 1; and (b) represents the measurements of reflectivity vs. positions along the thickness direction in the optical information recording medium according to Example 2.

### DESCRIPTION OF EMBODIMENT(S)

Next, one embodiment of the present invention will be described below with reference to the drawings.

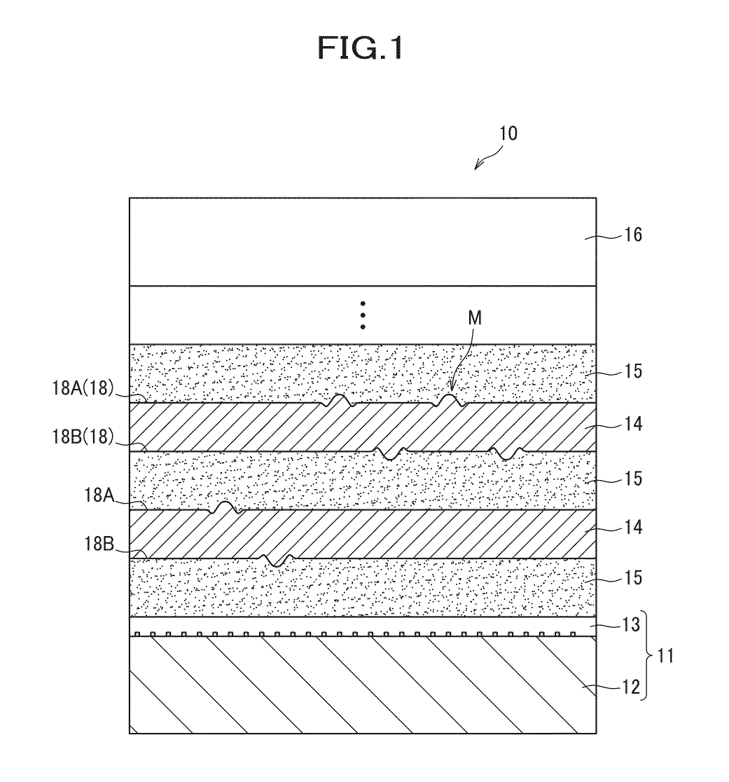

As shown in FIG. 1, an optical information recording medium 10 comprises a substrate 11, a plurality of recording layers 14, a plurality of intermediate layers 15, and a cover layer 16.

The substrate 11 comprises a support plate 12 and a servo signal layer 13. The support plate 12 is a supporting member for supporting the recording layer 14 and other layers, and is made of a polycarbonate disc, for example. The material for the support plate 12 and its thickness are not limited in particular.

The servo signal layer 13 is a layer which is made of a tacky or adhesive resinous material to retain a multilayer structure of the recording layers 14 and the intermediate layers 15 on the support plate 12, and of which a support plate 12 side surface has a servo signal pre-recorded as irregularities in shape or variations in refractive index. Herein, the servo signal is a signal being preset so that a recording and reading apparatus can recognize it as a reference surface for focus control during the recording and reading processes. In order to bring a specific recording layer 14 into focus, the focusing control is exercised with consideration given to the distance measured and/or the number of interfaces counted from the reference surface. Furthermore, a track-following servo signal or groove may preferably be provided so that a track of circumferentially arranged recording spots can be, illuminated accurately with a laser beam during the recording and reading processes. It is appreciated that presence or absence of the servo signal layer 13 is optional.

The recording layer 14 is a layer made of a photosensitive material in which information is optically recordable; in this embodiment, the recording layer 14 contains a polymer binder and a dye dispersed in the polymer binder. When the recording layer 14 is irradiated with a recording beam, the dye absorbs the recording beam and generates heat, which causes the polymer binder to deform so as to form a protrusive shape protruding into the intermediate layer 15 at the interface 18 between the recording layer and an intermediate layer 15 (the term “interface 18” will be used hereafter if a distinction is not drawn between the upper and lower interfaces of the recording layer 14), so that a recording spot M (information) is recorded. To be more specific, as will be described later, the recording spot M has its center shaped like a protrusion and its circumferential area shaped like a recess such that the protrusive shape protrudes from the recording layer 14 into the intermediate layer 15 and the recess is set back from the intermediate layer 15 into the recording layer 14 (as seen with reference to the recording layer 14).

In the present application, the conceptual layer in which recording spots M are formable at the interface 18 so that information is written therein will be referred to as “information layer”.

To this end, the recording layer 14 is thicker than conventional recording layers containing a polymer binder and a dye; preferably, one recording layer 14 has a thickness not less than 2 micrometers. The thickness of one recording layer 14 may preferably be 5 micrometers or greater, and more preferably be 7 micrometers or greater. This is because if the recently published method of homodyne detection using interference with a reference beam (Tatsuro Ide et al., Reduction of Interlayer Crosstalk in Multilayer Optical Disk by using Phase-diversity Homodyne Detection, ISOM′ OWB3(2011)) is adopted, 2 micrometers or greater spacing between information layers enables detection of a signal by separation from a signal derived from an adjacent information layer. Even if a conventional signal separation method without utilizing a reference beam is adopted, the thickness of 5 micrometers or greater enables separation from a signal derived from an adjacent information layer. To be more specific, when the interface 18 is detected as an information layer by the conventional method, in the optical information recording medium 10 according to the present embodiment 10, detection is performed based upon the intensity of reflection varying according to the position in the thickness direction; however, if spacing between information layers is less than 5 micrometers, wider bottoms of the peaks of the intensity of reflection overlap each other as seen in the graph of reflection intensity vs. thickness direction position, which makes the peaks indistinct. Thus, if the thickness of a recording layer 14 is less than 5 micrometers, there is a possibility of interlayer crosstalk occurring when recording spots M recorded (deformed) at the interfaces 18 between the recording layer 14 and the intermediate layer 15 disposed adjacently to the topside of the recording layer 14 (hereinafter referred to as “first interface 18A”) and the recording sports M recorded at the interfaces 18 between the recording layer 14 and the intermediate layer disposed adjacently to the underside of the recording layer 14 (hereinafter referred to as “second interface 18B”) are read out. For example, when the recording spots M at the first interface 18A are read out, separation of the signal from reflected light from recording spots recorded at the second interface 18B located immediately below may become difficult; therefore, it is preferable that the recording layer 14 is 5 micrometers or thicker.

Since multiphoton absorption reaction caused by a sufficiently converged recording beam RB occurs approximately in a range of 0.5 to 2 micrometers in the direction of thickness of the recording layer 14, the thickness of the recording layer 14 may preferably be 2 micrometers or greater, or 5 micrometers or greater with a margin increased in consideration of the precision in pinpointing the focal position or an error in regard to the focal position during recording. In this way, when deformation is to be effected at only one of the first interface 18A and the second interface 18B, the other of the first interface 18A and the second interface 18B of the same recording layer 14 can be prevented from being caused to deform.

Although the thickness of the recording layer 14 does not have an upper limit, the thinner the layer, the better it may be as long as no interlayer crosstalk would occur, for example, the thickness of 20 micrometers or less may be preferable, in order to increase the number of recording layers 14.

It is assumed that the recording layer 14 in this embodiment described herein has a thickness of 12 micrometers which is taken by way of example.

The number of the recording layers 14 provided may be approximately in the range of 2 to 100 layers. To increase the storage capacity of the optical information recording medium 10, the more the number of the recording layers 14, the better it may be; for example, it is preferable that ten or more layers are provided. Moreover, the material for the recording layer 14 is selected among those of which the refractive index may substantially not change before and after recording which causes deformation of the interface 18.

The recording layer 14 may preferably have a recording beam absorption ratio (of one-photon absorption) equal to or less, than 5% per one layer. Further, this absorption ratio may be more preferably equal to or less than 2%, and further more preferably equal to or less than 1%. This is because, for example, if the intensity of the recording beam which reaches the deepest recording layer 14 has to be equal to or more than 50% of the intensity of the radiated recording beam, it is necessary that the absorption ratio per one recording layer is equal to or less than 4% in order to obtain fifteen-layered recording layers (thirty-layered information layers), and it is necessary that the absorption ratio per one recording layer is equal to or less than 2% in order to obtain twenty-five-layered recording layers (fifty-layered information layers). If the absorption ratio is higher, the recording layer 14 is likely to be overheated and thus formation of a protrusive shape in the interface 18 becomes difficult.

The recording layer 14 may be formed by any method without limitation; for example, it may be formed by spin coating or blade coating using a liquid obtained by dissolving a dye material and a polymer binder in a solvent. Examples of the solvent usable for this purpose may include dichloromethane, chloroform, methyl ethyl ketone (MEK), acetone, methyl isobutyl ketone (MIBK), toluene, hexane, and the like.

Examples of the polymer binder for use in the recording layer 14 may include polyvinyl acetate (PVAc), polymethylmethacrylate (PMMA), polyethylmethacrylate, polybutylmethacrylate, polybenzylmethacrylate, polyisobutylmethacrylate, polycyclohexylmethacrylate, polycarbonate (PC), polystyrene (PS), polyvinyl chloride (PVC), and polyvinyl alcohol (PVA), polyvinyl benzoate, poly(vinyl pivalate), polyethylacrylate, polybutylacrylate, and the like.

Examples of the recording beam-absorbing dye for use in the recording layer 14 may include dyes (one-photon absorption dyes) which have been conventionally used as a heat mode type recording material. For example, a phthalocyanine-based compound, an azo compound, an azo metal complex compound, and methine dyes (e.g., a cyanine-based compound, an oxonol-based compound, a styryl dye, and a merocyanine dye) may be used. Further, for recording beam-absorbing dyes in a recording medium having a plurality of recording layers, those which contain a multiphoton absorption dye are preferable in order to minimize adverse effects on adjacent recording layers during recording/reading processes. As an example of the multiphoton absorption dye, a two-photon absorption compound having no linear absorption in the wavelength range of the reading beam is preferable. The dyes constituting 1-80% by weight may preferably be contained in, the recording layer. More preferable may be those constituting 5-60% by weight, and further more preferable may be those constituting 10-40% by weight.

As long as the two-photon absorption compound has no linear absorption in the wavelength range of the reading beam, any known two-photon absorption compound may be used without limitation; for example, compounds having a structure represented by the following general formula (1) may be used.

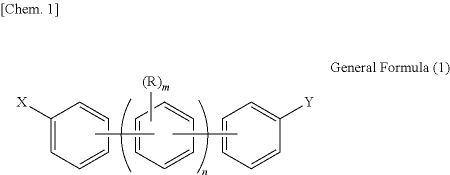

In the general formula (1), X and Y each represent a substituent having a Hammett's sigma-para value (σp value) of 0 or more, which may be the same as or different from each other; n represents an integer of 1 to 4; R represents a substituent, and a plurality of Rs may be the same as or different from one another; and m represents an integer of 0 to 4.

In the general formula (1), each of X and Y represents a group having a σp value taking a positive value in Hammett equation, i.e., what is called an electron-withdrawing group, which preferably includes, e.g., a trifluoromethyl group, a heterocyclic group, a halogen atom, a cyano group, a nitro group, an alkylsulfonyl group, an arylsulfonyl group, a sulfamoyl group, a carbamoyl group, an acyl group, an acyloxy group, an alkoxycarbonyl group and the like, more preferably a trifluoromethyl group, a cyano group, an acyl group, an acyloxy group, and an alkoxycarbonyl group, and most preferably a cyano group and a benzoyl group. Of these substituents, an alkylsulfonyl group, an arylsulfonyl group, a sulfamoyl group, a carbamoyl group, an acyl group, an acyloxy group and an alkoxycarbonyl group may further have a substituent for various purposes including giving solubility in a solvent. The examples of such substituents preferably include an alkyl group, an alkoxy group, an alkoxyalkyl group, an aryloxy group, etc.

n preferably is 2 or 3, and most preferably 2. If n is 5 or more, the greater n becomes, the more the linear absorption appears at the longer wavelength side, so that non-resonant two-photon absorption recording is not done with a recording beam at a wavelength range shorter than 700 nm.

R represents a substituent. The substituent is not specifically limited, and an alkyl group, an alkoxy group, an alkoxyalkyl group, and an aryloxy group are exemplified as specific examples.

The compound having the structure represented by the general formula (1) is not limited to specific examples; the compounds represented by the following chemical structural formulae D-1 to D-21 may be used.

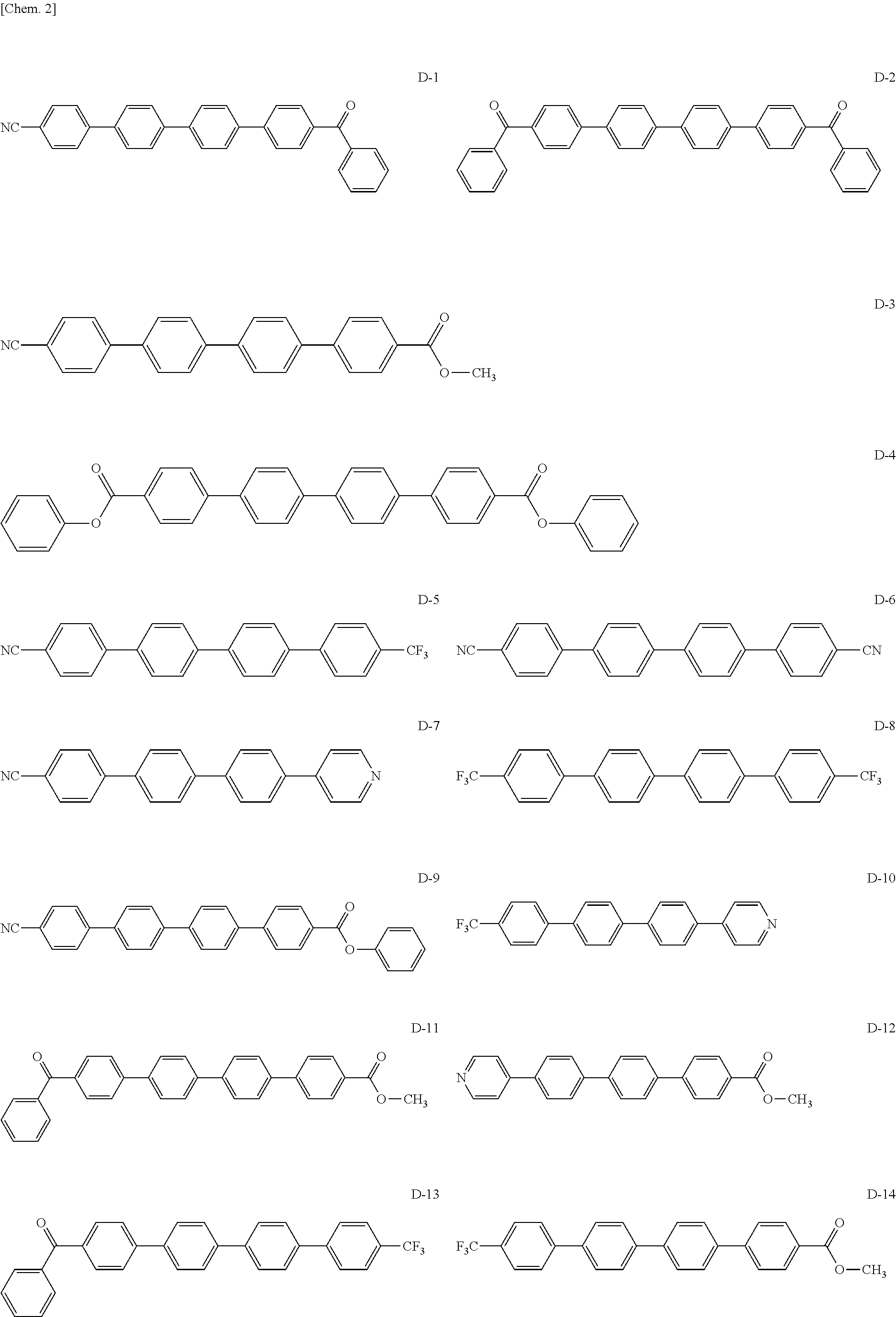

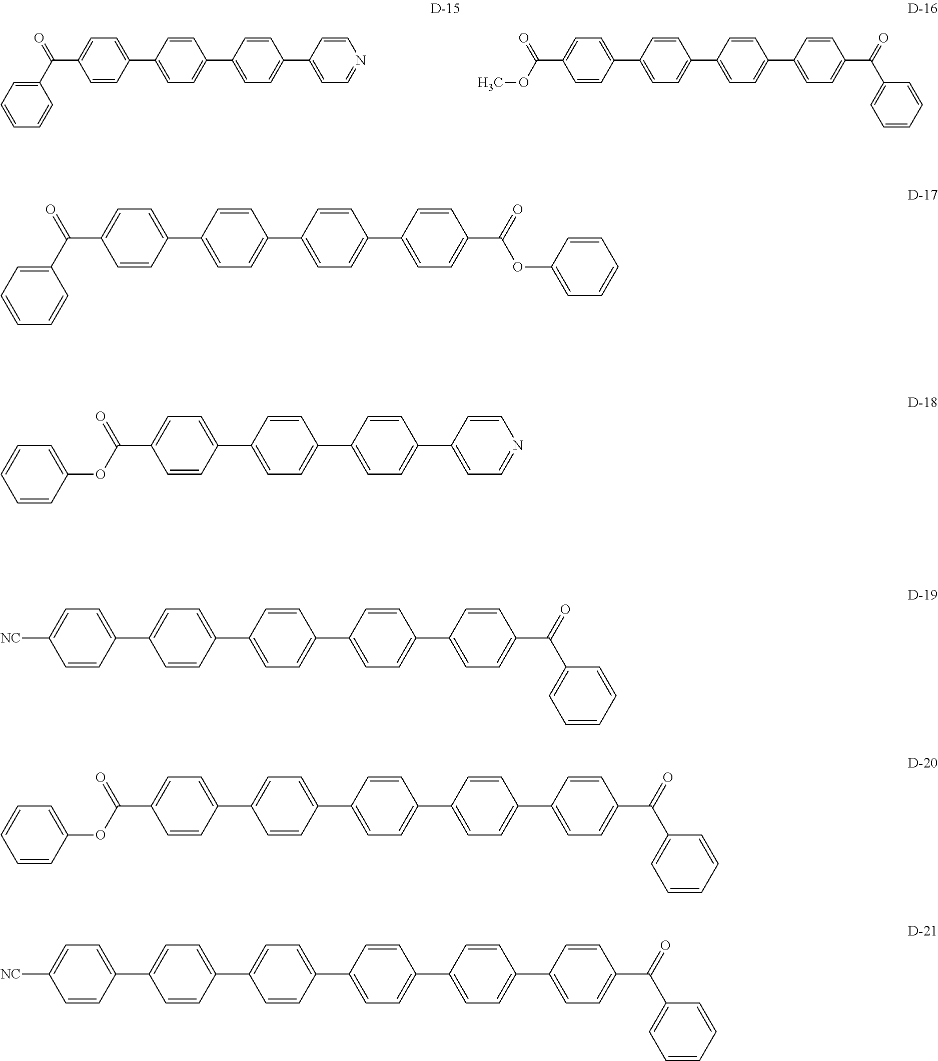

The intermediate layer 15 is provided between the recording layers 14. In other words, the intermediate layer 15 is provided adjacent to the topside and underside of each recording layer 14. In order to prevent interlayer crosstalk across a plurality of recording layers 14, the intermediate layer 15 is provided to form a predetermined amount of space between the recording layers 14. For this purpose, the thickness of the intermediate layer 15 is equal to or more than 2 micrometers, preferably equal to or more than 5 micrometers, and in the present embodiment as one example, it is 10 micrometers. The intermediate layer 15 is preferably as thin as possible as long as the interlayer crosstalk can be prevented, and for example, may preferably be not thicker than 20 micrometers.

It has been shown that if a recording material with a dye-dispersed polymer binder dissolved in a solvent is applied to a thickness of 5 micrometers or more as in the present embodiment, some refractive index distribution (variations) is observed along its thickness direction. Accordingly, in the optical information recording medium 10 according to the present embodiment, the refractive indices of the first interface 18A and the second interface 18B as observed when the interfaces 18 are scanned with light during recording or reading process are different from each other, with the result that the position of the information layer can be pinpointed with increased ease. Such a difference in refractive index can be created only through a simple operation of application of the recording layer as conventionally performed, with no special step required; therefore, the productivity is good.

The intermediate layer 15 is made of a material which is unreactive to irradiation with a laser beam applied during recording and reading operations. Further, in order to minimize the loss of the recording beam, the reading beam, and a read-back beam (a beam of light in which a read-back signal generated by irradiation with a reading beam is embedded), it is preferable that the intermediate layer 15 is made of a material which is transparent to the recording beam, the reading beam, and the read-back beam. Herein, the term “transparent” indicates that the absorption ratio thereof is equal to or less than 1%.

The intermediate layer 15 is composed of an adhesive layer. This adhesive layer has an adhesive property that enables sticking to a surface of another object, and is softer than the recording layer 14. For example, the adhesive layer has a glass transition temperature lower than the glass transition temperature of the recording layer 14. Use of such an adhesive layer softer than the recording layer 14 for the intermediate layer 15 serves to facilitate deformation of the intermediate layer 15 caused by expansion of the recording layer 14 heated by the recording beam, so that deformation can be effected at the interface 18 with ease.

The intermediate layer 15 has a refractive index different from the refractive index of the recording layer 14. This enables reflection of the reading beam OB by the steep change in refractive index at the interface between the recording layer 14 and the intermediate layer 15. The intermediate layer 15 may preferably be configured to differ moderately from the recording layer 14 in refractive index. To be more specific, it is preferable that the following inequality is satisfied:

0.001<((n2−n1)/(n2+n1))²≦0.04

where n1 represents the refractive index of the recording layer 14, and n2 represents the refractive index of the intermediate layer 15.

Since ((n2−n1)/(n2+n1))², i.e., the reflectivity, is greater than 0.001, the quantity of light reflected at the interface 18 is large, so that a high signal-to-noise ratio is achieved in the process of reading information. On the other hand, since the reflectivity is smaller than 0.04, the quantity of light reflected at the interface 18 is restricted to a moderate magnitude, so that the recording/read-back beam can reach deeper recording layers 14 without undergoing considerable attenuation in the recording and reading processes. This makes it possible to increase the storage capacity by providing a large number of recording layers 14.

The refractive index n2 of the intermediate layer 15 may be 1.460 by way of example. When the refractive index n1 of the recording layer 14 is 1.565, ((n2−n1)/(n2+n1))² is 0.001205 which satisfies the above inequality.

In order to adjust the refractive indices of the recording layer 14 and the intermediate layer 15, the composition of the materials for use in the recording layer 14 and for use in the intermediate layer 15 may be adjusted. To be more specific, since the material for the recording layer 14 is prepared by mixing a dye such as a two-photon absorption compound in the polymer binder, the refractive index thereof can be adjusted as desired by appropriately selecting the dye or the polymer binder having an appropriate refractive index and changing their respective composition ratios. The refractive index of the polymer binder varies depending on the degree of polymerization even if they have similar basic constitution. Therefore, the refractive index thereof can also be adjusted by using polymer binders with different degrees of polymerization or by adjusting the degree of polymerization of the polymer binder. Further, adjustment can be made by mixing different kinds of polymer binders. Further, a refractive index matching material (inorganic particulate and the like) may be added to adjust the refractive index.

To adjust the refractive index of the intermediate layer 15, the degree of polymerization of the polymer material such as a resin usable as the material for the intermediate layer 15 may be adjusted. As an alternative, a material usable for the intermediate layer 15 may be optionally added to adjust the refractive index, or the adjustment can also be made by adding a refractive index matching material (inorganic particulate and the like).

The cover layer 16 is a layer provided to protect the recording layers 14 and the intermediate layers 15, and is made of a material which allows the recording/read-back beam to pass through the cover layer 16. The cover layer 16 has an appropriate thickness in the range from several tens micrometers to several millimeters.

A method for recording and reading information in the optical information recording medium 10 as described above will be described hereafter.

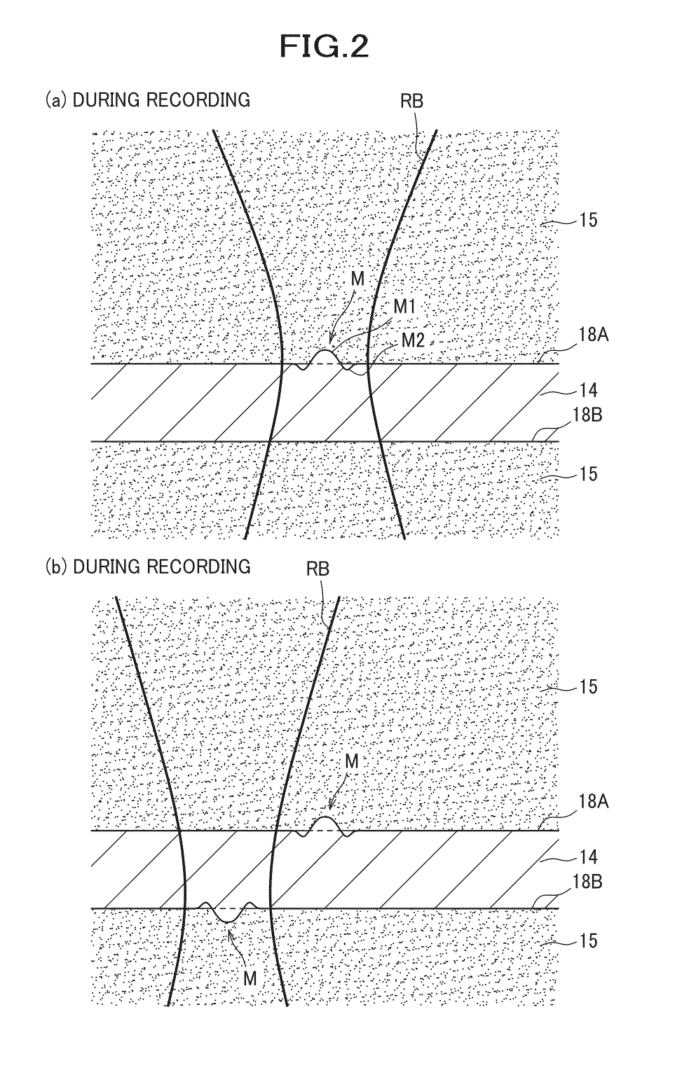

To record information in a desired interface 18, e.g., first interface 18A, as seen in FIG. 2(a), a region of the recording layer 14 adjacent to the first interface 18A is irradiated with a laser beam (recording beam RB) the output of which is modulated in accordance with the information to be recorded. If, the recording layer 14 contains a multiphoton absorption compound as a recording dye, it is preferable that the laser beam used for this recording may be a pulsed laser beam, the peak power of which can be increased. The focal position of the recording beam RB may be, for example, targeted at the interface 18.

When a recording beam RB is applied, a center of an area on which the recording beam RB is applied takes a protrusive shape protruding from the recording layer 14 into the intermediate layer 15 and forms a recording spot M (pit). In this way, the first information layer is formed at the first interface 18A in the recording layer 14. More specifically, the recording spot M includes a center portion which forms a protrusion M1, and an annular recessed portion M2 which surrounds the protrusion M1 and is recessed into the recording layer 14. The distance from the first interface 18A (the first interface 18A before undergoing a change in shape) to the deepest portion of the recessed portion M2 is smaller than the distance from the first interface 18A (the first interface 18A before undergoing a change in shape) to the peak of the protrusion M1. In other words, the recording spot M can be considered to assume a generally protrusive shape as a′ whole. Although the principle of formation of the recording spot M having a protrusively shaped center portion has not been fully elucidated, one assumption as will be described below can be made on the analogy of the hitherto known principle of formation of a recessed shape in the recording scheme by which a center of an area on which the recording beam is applied takes a recessed shape (this principle is also explained based on an assumption).

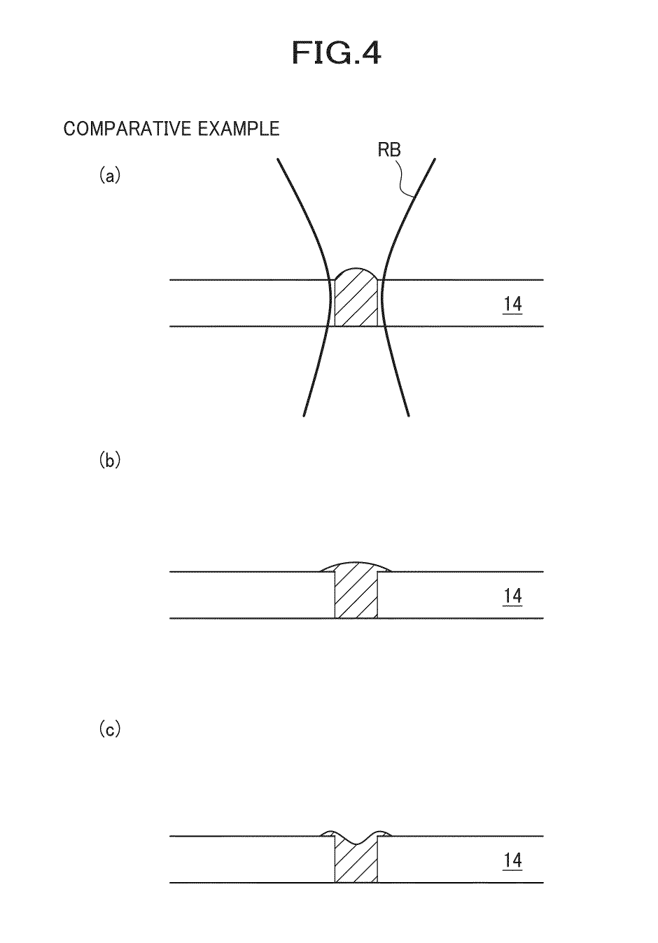

First, an overview of the conventional recording scheme is summarized with reference to J. Appl. Phys. 62 (3), 1 Aug. 1987 as follows: when a recording beam is applied to a recording material, the temperature of the recording material is caused to increase and the recording material (recording layer 14) expands as shown in FIG. 4(a) (the hatched area shows a heated region); then, as shown in FIG. 4(b) a portion that has been expanding flows out onto the surrounding area under surface tension; thereafter, as the temperature lowers, the recording material that has expanded contracts and a portion that has flowed out on the surrounding area around the irradiated area is left at a level higher than the reference surface (on the upper surface of the recording layer 14) to form a protrusion but a center portion lowers to a level lower than the reference surface as a result of the outflow of the material to form a recessed portion, as shown in FIG. 4(c).

In contrast, in the optical information recording medium 10 configured according to this embodiment, when a recording beam RB is applied, the recording layer 14 thermally expands, and the recording layer 14 bulges as shown in FIG. 4(a). However, in this embodiment, the viscosity of a portion of the recording layer 14 near its surface will not lower to such a level as in the conventional scheme because the recording layer 14 is relatively thicker, and thus the outflow as shown in FIG. 4(b) will not occur. Therefore, when the portion which has expanded contracts with decreasing temperature, that portion deforms from the shape shown in FIG. 4(a) to the shape shown in FIG. 2 such that a protrusion M1 is left at the center and a recessed portion M2 is formed around the protrusion M1.

In the optical information recording medium 10 according to the present embodiment, in regions adjacent to not only the first interface 18A at the topside of one recording layer 14 but also the second interface 18B of the same recording layer 14, recording spots M each having a protrusive shape protruding into the intermediate layer 15 can be formed by irradiating these regions with a laser beam (recording beam RB) the output of which is modulated in accordance with information to be recorded. In this way, in the recording layer 14, another information layer distinct from the information layer formed at the first interface 18A can be formed. In other words, the both of the first interface 18A and the second interface 18B can serve as independent information layers in which information can be recorded.

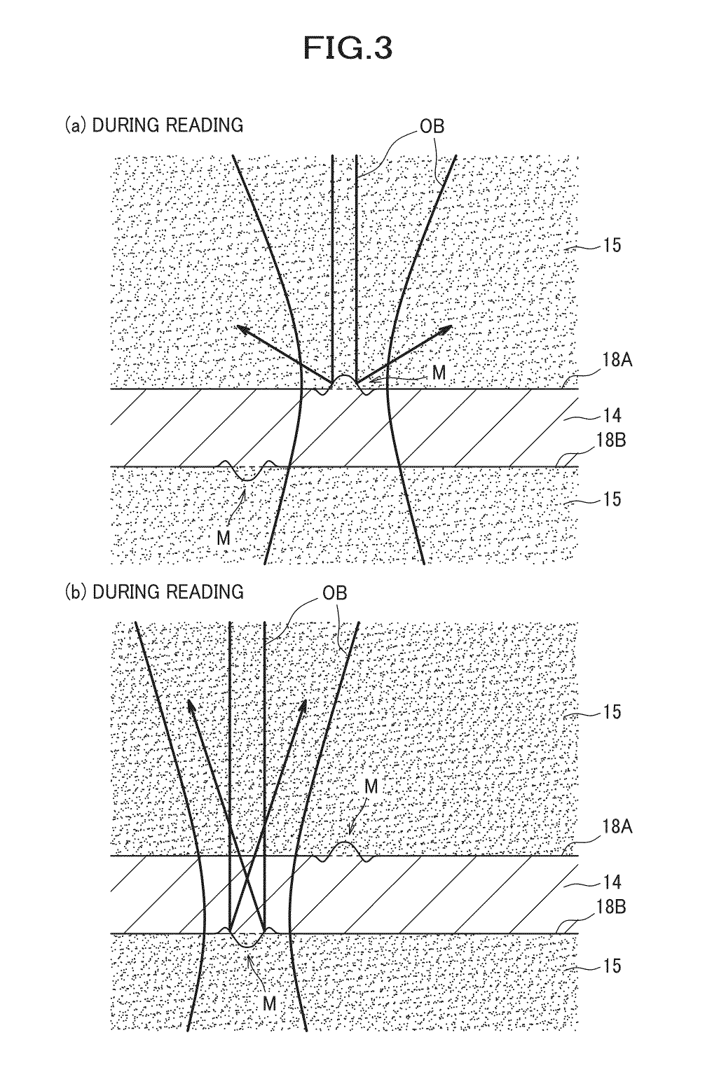

As shown in FIG. 3(a), when a recording spot M at the first, interface 18A is irradiated with the reading beam OB produced by a continuous-wave laser, the reading beam OB is reflected off the first interface 18A because of a difference between the refractive index of the recording layer 14 and the refractive index of the intermediate layer 15. At this time, a difference in, light intensity between a portion of the first interface 18A around the recording spot M and the recording spot M is observed, and thus the recording spot M can be detected based upon this difference in reflectivity. Since the refractive index of the recording layer 14 does not change from before recording, the reflection of the reading beam OB does not occur inside the recording layer 14 but only occurs at the first interface 18A; therefore, the recording spot M can be detected stably. To enable such optical detection, it is considered to be preferable that the protrusion M1 protrudes beyond a position of the interface (first interface 18A) before undergoing a change in shape, to such an extent that ranges from 1 to 300 nm or so.

Similarly, as shown in FIG. 3(b), when a recording spot M at the second interface 18B is irradiated with the reading beam OB produced by the continuous-wave laser, the reading beam OB is reflected off the second interface 18B because of a difference between the refractive index of the recording layer 14 and the refractive index of the intermediate layer 15. At this time, a difference in light intensity between a portion of the second interface 18B around the recording spot M and the recording spot M is observed, and thus the recording spot M can be detected based upon this difference in reflectivity.

It is to be understood that the recording spot formed in the optical information recording medium 10 may, as the case may be, only have a protruding shape (protrusion M1) with no recessed portion M2 formed around the protruding shape, depending on the recording conditions.

In this embodiment, the recording spot M has a recessed portion M2 formed around the protrusion M1, and thus distribution of the intensity of light reflected off a recording spot M when a reading beam OB for detecting a recording spot M is applied to the recording spot M is expected to change steeply according to the distance from the center of the protrusion M1, more steeply than the configuration in which only the protrusion M1 is present, with the result that a read-back signal with a higher degree of modulation can be obtained.

To erase the information recorded in the recording layer 14, the recording layer 14 is heated to a temperature around the glass transition temperature of the polymer binder, preferably to a temperature higher than the glass transition temperature, so that the fluidity of the polymer binder is increased and the deformation in the interface 18 disappears due to surface tension to thereby return to its original plane shape; as a result, the information recorded in the information layer can be erased. Because the information is erasable, re-recording (repeated recording) in the recording layer 14 (information layer) is possible. When the recording layer 14 is heated for that purpose, a method of irradiating the recording layer 14 with a continuous-wave laser beam while focusing the laser beam on the recording layer 14 can be adopted. Through heating by a continuous-wave laser, the information recorded in a continuous region within the recording layer 14 can be erased completely without omission. The continuous-wave laser used may be a laser used for reading back the information, or alternatively, another laser may be used. In either case, it is preferable that a laser configured to emit light having a wavelength at which a one-photon absorption can occur in the recording layer 14 is used.

Further, when information is to be erased by heating the recording layer 14, the optical information recording medium 10 may be heated as a whole to a temperature higher than the glass transition temperature of the polymer binder so that the information recorded in all the recording layers 14 can be erased at once. With this method, irrespective of the kind of dyes contained in the recording layer 14, all the information recorded in the optical information recording medium 10 can be erased easily for initialization. Moreover, when the optical information recording medium 10 is to be disposed of, the information can be easily erased.

As described above, with the optical information recording medium 10 according to this embodiment, the first interface 18A disposed on one side of the recording layer 14 and the second interface 18B disposed on, the other side of the recording layer 14 are both configured as independent information layers in which information is recordable. Since the recording layer 14 is not subject to change in refractive index before: and after recording, no reflection occurs inside the recording layer 14 (no interference occurs inside the recording spot M unlike the conventional technique), so that information can be read out stably. Since the optical information recording medium 10 does not require high fluidity in the recording layer 14 as would be required in the conventional case where recording is performed by forming a recessed shape, high-sensitivity recording can be realized accordingly.

Although the optical information recording medium 10 according to the present embodiment has been described above, the present invention can be implemented in an appropriately modified form without limitation to the above-described embodiment.

In the above-described embodiment, the recording layer 14 is configured to include a polymer binder and a dye dispersed in the polymer binder, but the present invention is not limited to this configuration; the recording layer may be configured to include a polymer to which a dye is bonded.

To be more specific, the recording layer 14 may contain a polymer having a structure represented by the following general formula (2).

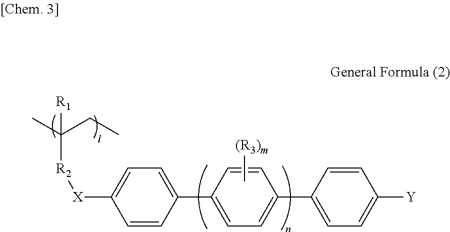

In the general formula (2), Y represents a substituent having a Hammett's sigma-para value (σp value) of 0 or more, X also represents the same kind of substituent. X and Y may be the same as or different from each other. n represents an integer of 1 to 4; R₁, R₂, R₃ represent substituents, which may be the same as or different from one another; l represents an integer not less than one; and m represents an integer of 0 to 4.

When a polymer to which a dye is bonded is used as a material for the recording layer 14, even if the material is applied to a thickness of 5 micrometer or greater, the refractive index distribution along the thickness direction can be made uniform. Accordingly, the first interface 18A and the second interface 18B have the same reflectivity, and consequently, the detection system for the reading operation can be one and the same system which can be used for reading at the first interface 18A and for reading at the second interface 18B; therefore, a detection system for the reading operation can be made easily configurable.

Next, one exemplary preferred method for manufacturing an optical information recording medium 10 as described above will be described hereafter.

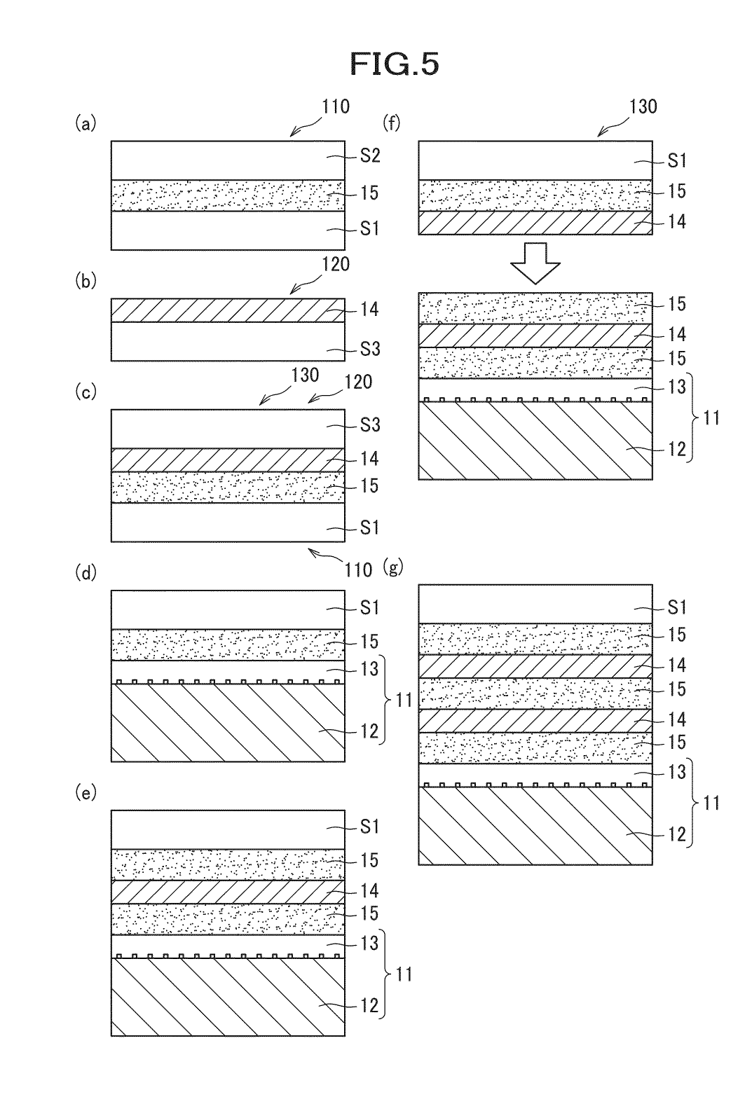

As shown in FIG. 5(a), an adhesive agent is applied on a surface of a first release sheet S1 on which a releasing agent is applied, to form an intermediate layer 15, and further a second release sheet S2 is stuck thereon, to provide a first sheet 110. The releasing agent applied to the second release sheet S2 used herein has a higher-grade releasing property such that a force required for peeling off the second release sheet S2 is weaker than a force required for peeling off the first release sheet S1.

Then, as shown in FIG. 5(b), a recording layer 14 is formed on a surface of a third release sheet S3 on which a releasing agent is applied, to make a second sheet 120. The method for forming the respective layers may be selected without limitation; for example, spin coating, knife coating, roll coating, bar coating, blade coating, die coating, gravure coating and any other methods of applying a layer-forming material may be adopted. It is to be understood that the steps of making the first sheet 110 and the second sheet 120 may be performed in any order without particular limitation.

Next, the second release sheet S2 is removed from the first sheet 110, and to the exposed intermediate layer 15 thereof, the recording layer 14 of the second sheet 120 is laminated to make a third sheet 130 as shown in FIG. 5(c). The third sheet 130 is a unit structure sheet in which the recording layer 14 and the adhesive layer (intermediate layer 15) are laminated between the two release sheets (S3, S1); a large number of the third sheets 130 may be fabricated in advance and kept in stock.

Next, a substrate 11 is prepared, while a second release sheet S2 is removed from a first sheet 110, of which the exposed adhesive layer is then laminated on a surface of the substrate 11 on the servo signal layer 13 side. Accordingly, a structure in which an intermediate layer 15 is laminated on the substrate 11 as shown in FIG. 5(d) (such an optical information recording medium in the process of manufacture will be referred to as “semi-manufactured medium”) is formed.

Next, the first release sheet S1 is removed from the semi-manufactured medium to expose the intermediate layer 15, while a separately prepared third sheet 130 is provided from which the release sheet S3 is removed to expose the recording layer 14 thereof, which recording layer 14 is then laminated on the intermediate layer 15 of the semi-manufactured medium, to form a semi-manufactured medium as shown in FIG. 5(e). Further, as shown in FIG. 5(f), the first release sheet S1 is removed from the semi-manufactured medium of FIG. 5(e) to expose the intermediate layer 15, while a separately prepared third sheet 130 is provided from which the release sheet S3 is removed to expose the recording layer 14 thereof, and this recording layer 14 is laminated on the intermediate layer 15 of the semi-manufactured medium, to form a semi-manufactured medium as shown in FIG. 5(g) in which three intermediate layers 15 and two recording layers 14 are alternately arranged on the substrate 11.

After that, the process steps as shown in FIGS. 5(f)-(g), in which a third sheet 130 from which the release sheet S3 is removed is laminated on the intermediate layer 15 of the semi-manufactured medium from which the release sheet S1 is removed, are repeated a necessary number of times, and finally, a cover layer 16 is laminated on the adhesive layer (intermediate layer 15) exposed as a result of removal of the outermost release sheet S1, so that an optical information recording medium 10 having a structure as shown in FIG. 1 can be manufactured.

Since the optical information recording medium 10 according to this embodiment has a structure in which adhesive layers (intermediate layers 15) and recording layers 14 are repeatedly laminated, the process of repeatedly laminating a unit structure sheet in which a recording layer and an adhesive layer are laminated between two release sheets can be adopted and thus the manufacturing process can be simplified.

The sheet for use in the manufacturing process as described above may be made to have an area larger than the optical information recording medium shaped as a final product, and the optical information recording medium can be efficiently manufactured by stamping the sheet manufactured by the laminating process described above into the shape of the optical information recording medium as the final product.

### EXAMPLES

Next, a description will be given of experiments in which a recording test was carried out for an optical information recording medium according to the present invention.

### Example 1

The recording material, used in Example 1, includes a polymer binder and a dye dispersed in the polymer binder.

### (1) Polymer Binder

Polymethylmethacrylate 19376 (manufactured by SIGMA-ALDRICH Corporation) was used as a polymer binder.

### (2) Dye

The two-photon absorption dye represented below in C-2 was used as a dye.

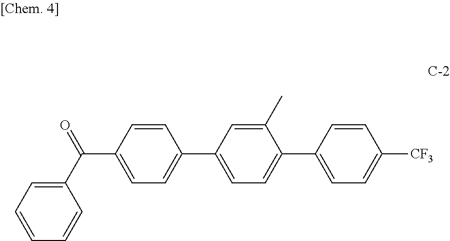 [SMILES: Cc1cc(-c2ccc(C(=O)c3ccccc3)cc2)ccc1-c1ccc(C(F)(F)F)cc1]

2. Making recording medium

2-butanone (manufactured by Wako Pure Chemical Industries, Ltd.) was used as a solvent, into which the aforementioned polymer binder and dye were mixed and stirred for 1 hour and dissolved therein to prepare a recording layer solution.

A release film (Clean Separator HY-US20, manufactured by Higashiyama Film Co., Ltd.) was cut into a piece on the order of 10 cm in width and 20 cm in length, which was placed on a smooth glass plate, and the recording layer solution was applied thereon manually with a blade coater and dried to form a recording layer.

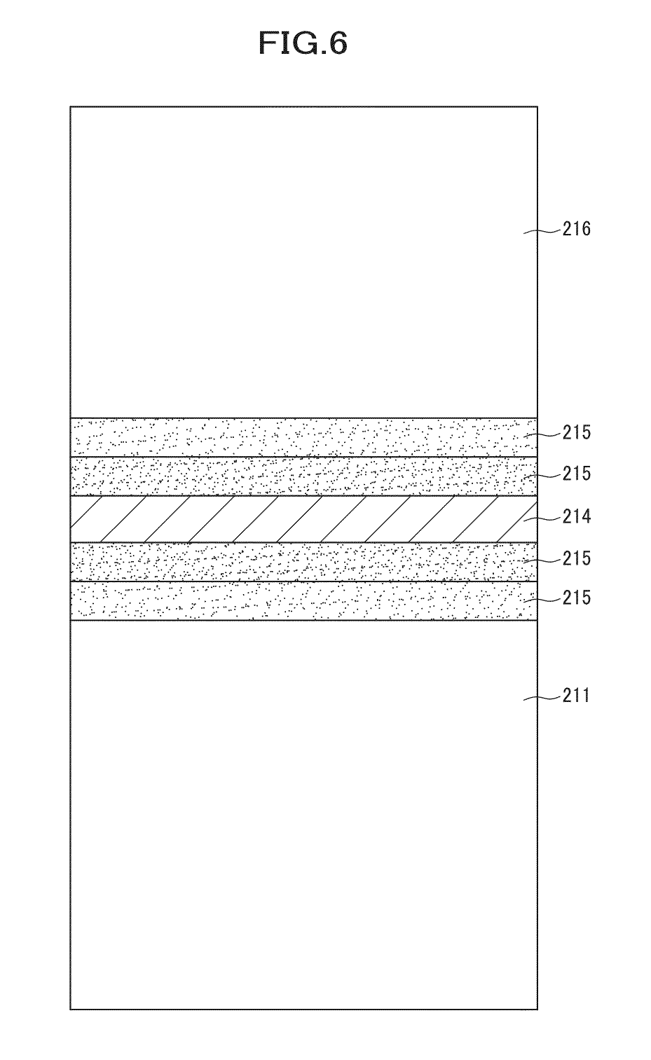

As shown in FIG. 6, an approximately 2×3 cm-sized adhesive layer 215 (DA-3010, manufactured by Hitachi Chemical Co., Ltd.) was stuck twice on a glass slide 211 (substrate), and a recording layer formed on a release film was disposed to face to the adhesive layer 215 and stuck thereon (see the recording layer 214 in FIG. 6). Thereafter, the release film was removed, and the adhesive layer 215 (DA-3010) was further stuck twice on the recording layer 214. Lastly, a polycarbonate film (PURE-ACE C110, manufactured by Teijin Chemicals Ltd.) as a cover layer 216 was stuck thereon.

Film thicknesses of the respective layers were measured by MINICOM ELECTRONIC GAGE (TOKYO SEIMITSU) as follows:

| Glass slide | 1000 | micrometers |
|---|---|---|
| Cover layer | 80 | micrometers |
| Adhesive layer (per sheet) | 10 micrometers for each sheet | |
| Recording layer | 12 | micrometers |

### Example 2

The recording material, used in Example 2, includes a polymer binder to which a dye is bonded.

(1) As a polymer binder to which a dye is bonded, the compound represented below was used.

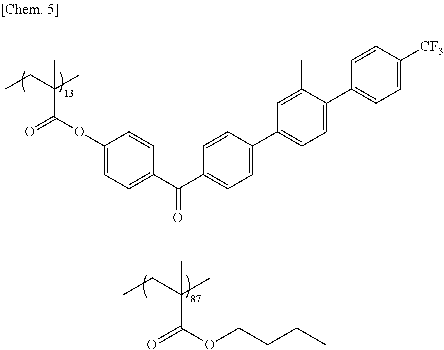

(2) Making recording medium

2-butanone (manufactured by Wako Pure Chemical Industries, Ltd.) was used as a solvent, into which the aforementioned polymer binder to which a dye is bonded was mixed and stirred for 1 hour and dissolved therein to prepare a recording layer solution. Thereafter, using the same materials and following the same process steps as in Example 1 except that the recording layer solution was different, a recording medium having a structure shown in FIG. 6 was made.

Film thicknesses of the respective layers were measured by MINICOM ELECTRONIC GAGE (TOKYO SEIMITSU) as follows:

| Glass slide | 1000 | micrometers |
|---|---|---|
| Cover layer | 80 | micrometers |
| Adhesive layer (per sheet) | 10 micrometers for each sheet | |
| Recording layer | 11.5 | micrometers |

### <Recording and Reading Tests>

A pulsed laser having a 522 nm wavelength was used as a recording laser, and recording was performed with a peak power of 36.8 W and a pulse width of 10 microsecond, on the substrate-side interface and the cover-side interface, in this order, of the recording layer.

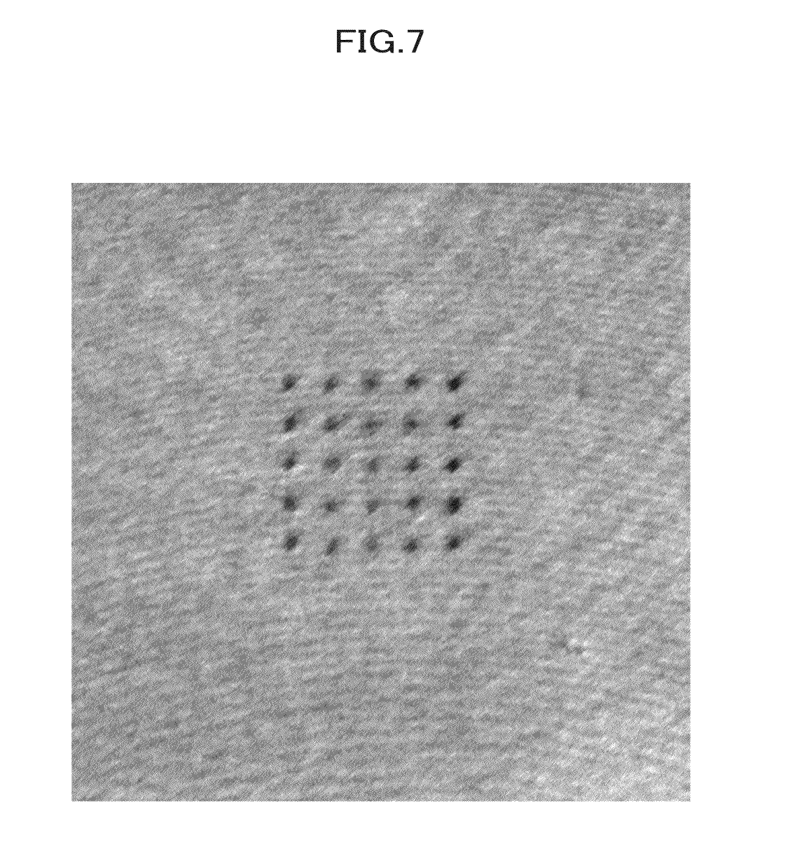

A CW (continuous wave) laser of 405 nm was used as a laser for reading recording spots, and intensities of reflection in some positions in the thickness direction are graphically represented in an image. To be more specific, images of the intensities of reflection in some positions were created in the thickness direction, based upon the intensities of reflected light derived from a reading laser beam. The results of imaging of the states changed before/after recording were depicted in FIGS. 7-10.

After recording on the substrate-side interface of the recording layer, observations were made on the same interface, and recording spots were found observable in the high-to-low state (i.e. the state in which recording spots are seen dark in bright unrecorded area) as shown in FIG. 7.

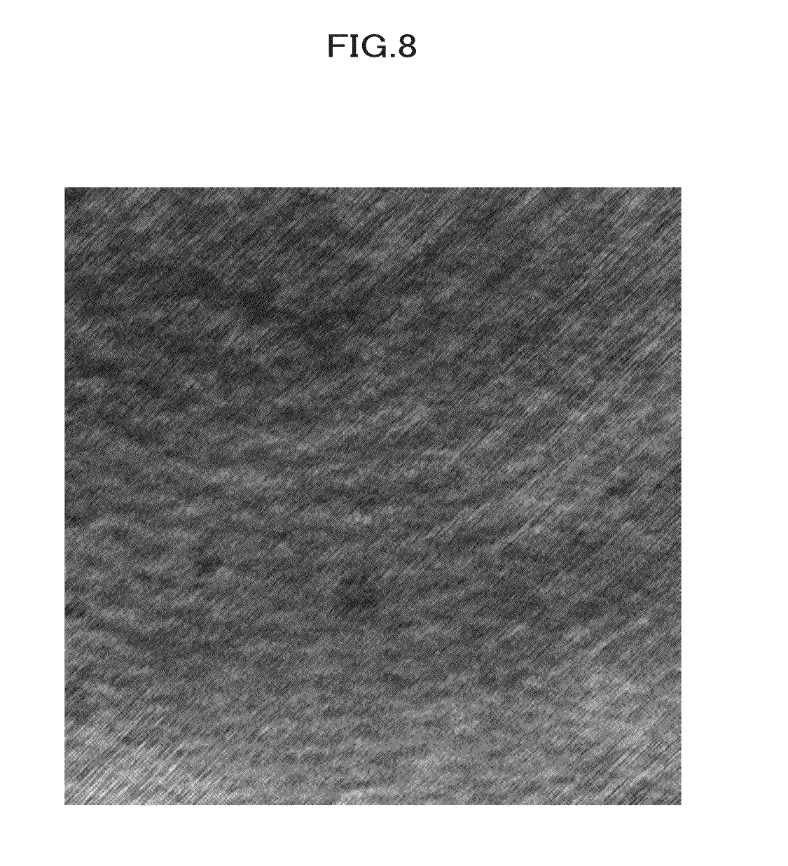

Thereafter, the focus was shifted 5 micrometers to the front (to the cover layer side) from the substrate-side interface of the recording layer, and the image shown in FIG. 8 was obtained. In other words, it was shown that formation of recording spots on the substrate-side interface of the recording layer would produce no observable damage in the recording layer in the position 5 micrometers shifted in the thickness direction. Thus, it has been affirmed that if the recording layer is provided with a 5 micrometer thickness, separate information layers can be formed on the upper and lower interfaces of the recording layer.

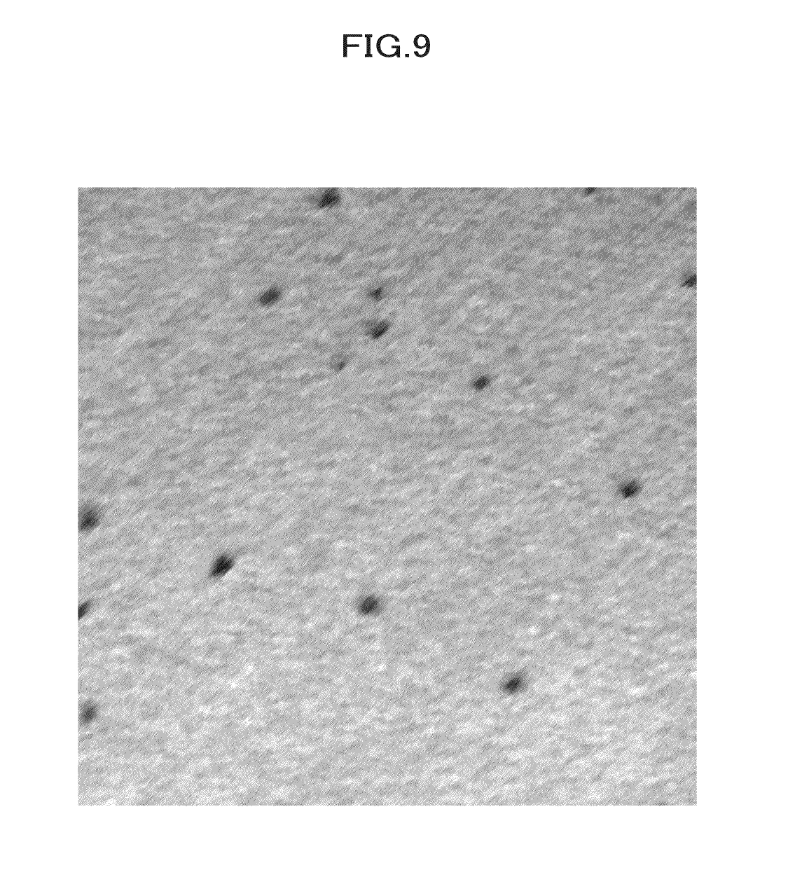

Further observations were made on the cover layer-side interface after recording effected on the substrate-side interface and before recording on the cover layer-side interface, and the result is shown in FIG. 9. As apparent from FIG. 9, no influence assumed to be exerted on the substrate-side interface of the recording layer during recording was observed, though some defects assumed to be produced during the process of making the sample were found.

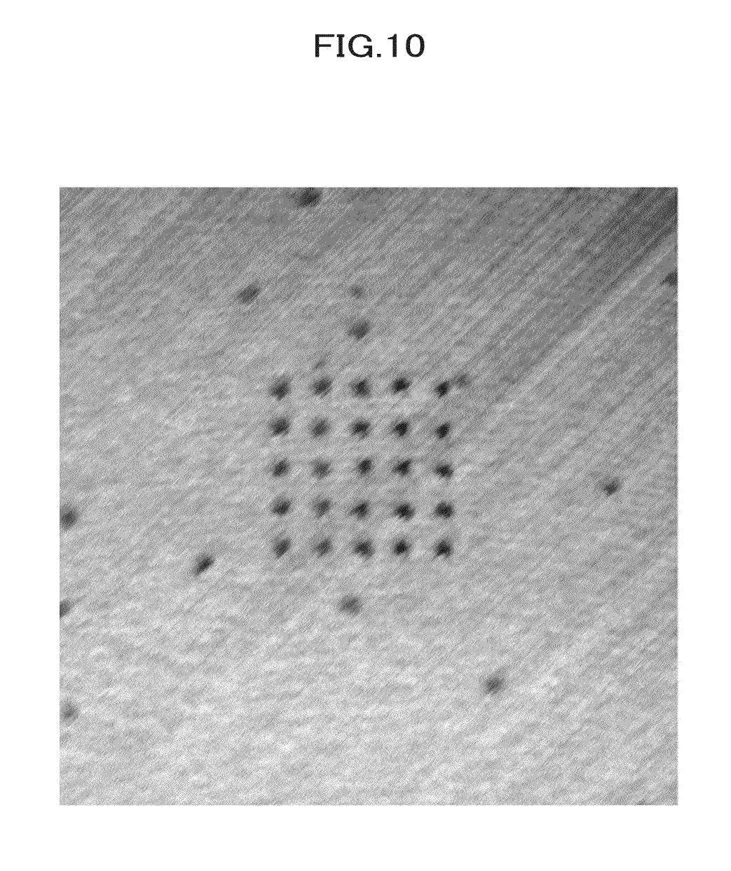

An image observed on the cover layer-side interface of the recording layer after recording effected thereon is shown in FIG. 10. As seen from FIG. 10, recording spots were found observable in the high-to-low state on the cover layer-side interface as well, like those observed on the substrate-side interface of the recording layer.

As described above, the recording spots formed on the substrate-side interface and on the cover layer-side interface were found clearly observable, respectively, by the optical microscope, and it has thus been shown that these recording spots were formed in a state enough to make them optically readable.

### <Evaluation of Deformation of Interfaces>

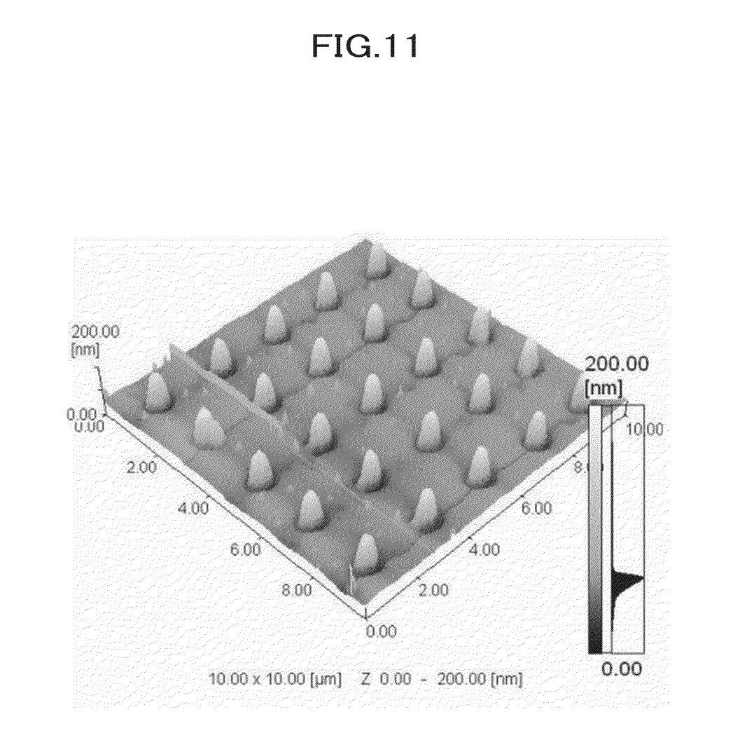

A medium of Example 1, in which recording spots were recorded and a cover layer-side adhesive layer was removed, was subjected to surface profiling using the atomic force microscope (AFM) specified below, and the results are shown three-dimensionally in FIG. 11. Of the interfaces on which recording was effected, an interface from which a recording beam had entered, the recording layer (cover-layer-side interface) was subjected to this profiling.

Atomic Force Microscope

Device:
Nano Search Microscope OLS-3500 (manufactured by Olympus Corporation)

Observation conditions:
Dynamic mode, Scanning range of 10 micrometers, scanning speed of 1 Hz
High-aspect-ratio probe AR5-NCHR-20 (manufactured by Nano World AG) was used.

As shown in FIG. 11, projections so formed as to protrude into the adhesive layer at the recording beam incident-side interface were found observable. Although the shape of the substrate-side interface of the recording layer was unable to be measured because an adhesive layer was adhered closely thereto, it is appreciated that recording was performed under the same conditions as it was for the cover layer-side interface and thus recording marks protruding into the adhesive layer were formed thereon.

### <Evaluation of Intensities of Reflection>

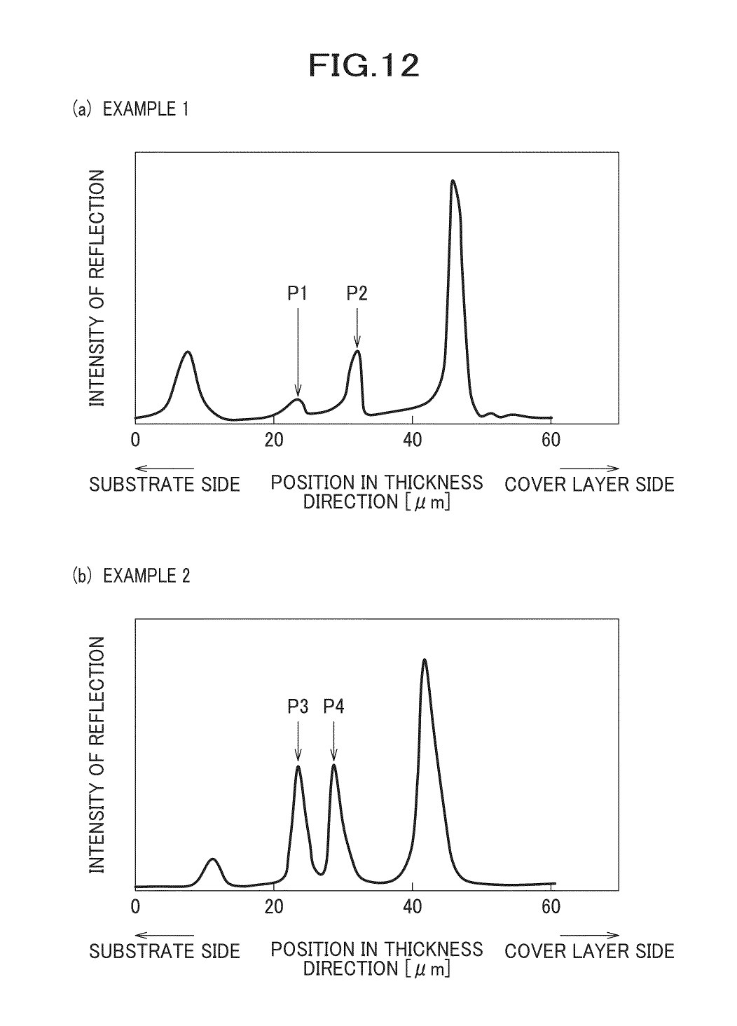

A 405-nm CW laser was used as a laser for reading recording spots, and the intensities of reflected light were measured with the focal position moved gradually from the substrate side to the cover layer side. As a result, in Example 1, as shown in FIG. 12(a), for the interfaces of the recording layer, a small peak P1 was detected on the substrate-side interface, and a peak P2 greater than the peak P1 was detected on the cover layer-side interface. In Example 2, as shown in FIG. 12(b), for the interfaces of the recording layer, a peak P3 was detected on the substrate-side interface, and a peak P4 having substantially the same height as that of the peak P3 was detected on the cover layer-side interface. Accordingly, it has been shown that in Example 1 implemented with a recording layer in which a dye is dispersed in a polymer binder, the substrate-side interface and the cover layer-side interface are different in reflectivity while in Example 2 implemented with a recording layer in which a polymer binder to which a dye is bonded is used, the substrate-side interface and the cover layer-side interface have substantially the same reflectivity. The measurements of intensities of reflection were carried out for unrecorded recording media.

What is claimed is:

1. An optical information recording medium comprising a plurality of recording layers and intermediate layers provided between the plurality of recording layers, which intermediate layers are made of adhesive layers,
wherein each recording layer includes a polymer binder and a dye dispersed in the polymer binder or includes a polymer to which a dye is bonded, the recording layer having a refractive index unchangeable under irradiation with a recording beam, with first and second interfaces being defined between the recording layer and two intermediate layers adjacent thereto, and
wherein the optical information recording medium is configured such that irradiation of a region of the recording layer adjacent to the first interface or a region of the recording layer adjacent to the second interface with the recording beam causes the dye to absorb the recording beam and generate heat which in turn deforms the polymer in the recording layer, forming a protrusive shape protruding into the intermediate layer at the first or second interface whereby information is recordable in separate information layers at both of the first and the second interfaces.

2. The optical information recording medium according to claim 1, wherein the recording layer has a thickness not less than 2 micrometers.

3. The optical information recording medium according to claim 1, wherein the first and second interfaces have the same reflectivity.

4. The optical information recording medium according to claim 3, wherein the recording layer includes a polymer to which a dye is bonded.

5. The optical information recording medium according to claim 1, wherein the first and second interfaces have different reflectivities.

6. The optical information recording medium according to claim 5, wherein the recording layer includes a polymer binder and a dye dispersed in the polymer binder.

7. The optical information recording medium according to claim 1, wherein the dye includes a multiphoton absorption compound.

8. A method for manufacturing an optical information recording medium according to claim 1, comprising the steps of:
forming unit structure sheets in which a recording layer and an adhesive layer are laminated between two release sheets; and
removing one of the release sheets from one unit structure sheet and laminating the same on another unit structure sheet from which the other of the release sheets are removed.

9. A recording method for an optical information recording medium, comprising the steps of:
providing an optical information recording medium including a plurality of recording layers and intermediate layers, wherein each recording layer includes a polymer binder and a dye dispersed in the polymer binder or includes a polymer to which a dye is bonded, the recording layer having a refractive index unchangeable under irradiation with a recording beam, and the intermediate layers are made of adhesive layers and provided between the plurality of recording layers;
irradiating a condensed recording beam in a region of the recording layer adjacent to one of interfaces between the recording layer and the intermediate layers, the one of the interfaces being located on one side in a thickness direction of the recording layer, thereby deforming the one of the interfaces into a protrusive shape protruding into the corresponding intermediate layer, to record information; and
irradiating a condensed recording beam in a region of the recording layer adjacent to the other of the interfaces between the recording layer and the intermediate layers, the other of the interfaces being located on the other side in the thickness direction of the recording layer, thereby deforming the other of the interfaces into a protrusive shape protruding into the corresponding intermediate layer, to record information.
